(19) United States
(12) Patent Application Publication
(10) Pub. No.: US 2026/0276477 A1
(43) Pub. Date: Sep. 17, 2026

(54) ANOMALY DETECTION METHOD AND DEVICE FOR VR DEVICE, VR DEVICE, AND STORAGE MEDIUM

(71) Applicants: Fu Tai Hua Industry (Shenzhen) Co., Ltd., Shenzhen (CN); HOH HAI PRECISION INDUSTRY CO., LTD., New Taipei (TW)

(72) Inventors: CHENG-CHING CHIEN, New Taipei (TW); CHO-PU TSAI, New Taipei (TW)

(21) Appl. No.: 19/230,533

(22) Filed: Jun. 6, 2025

(30) Foreign Application Priority Data
Mar. 14, 2025 (CN) 202510310602.5

(51) Int. Cl. G01M 11/02; G01N 29/04; G01N 29/22; G02B 27/01

(52) U.S. Cl. CPC G01M 11/0207; G01M 11/0285; G01N 29/041; G01N 29/223; G02B 27/0176; G02B 2027/0154; G02B 2027/0163

(57) ABSTRACT

An anomaly detection method and device for VR device, a VR device, and a storage medium. The VR device includes a main body, at least one speaker, a light shield and a microphone. a left temple and the right temple are also installed on the main body, the speaker is installed on the left temple or/and the right temple; the light shield is installed on one end of the main body; the microphone is installed on the side of the main body that is away from the light shield. In the method, a first audio frequency of a preset frequency band is emitted by controlling the speaker, a second audio frequency in a preset frequency band is received via the microphone, abnormality detection on the light shield is performed based on the second audio frequency. The viewing experience is improved through the application.

### FIELD

The present application relates to a technical field of Virtual Reality (VR) device, and more particularly to an anomaly detection method and device for VR device, a VR device, and a storage medium.

### BACKGROUND

Currently, VR devices can utilize computer-generated environments to simulate a user's physical presence, enabling users to interact with a 3D virtual world. However, when a wearer watches a media, there may be an issue of light leakage due to improper wearing of the light shield, resulting in a poor viewing experience for the wearer.

### BRIEF DESCRIPTION OF THE DRAWINGS

FIG. 1 is a first structural diagram of a VR device provided in an embodiment of the present application.

FIG. 2 is a second structural diagram of a VR device provided in an embodiment of the present application.

FIG. 3 is a flowchart diagram of an anomaly detection method provided in an embodiment of the present application.

FIG. 4 shows a schematic structural diagram of an anomaly detection device provided in an embodiment of the present application.

### DETAILED DESCRIPTION

The accompanying drawings combined with the detailed description illustrate the embodiments of the present application hereinafter. It is noted that embodiments of the present application and features of the embodiments can be combined, when there is no conflict.

Various details are described in the following descriptions for a better understanding of the present application, however, the present application may also be implemented in other ways other than those described herein. The scope of the present application is not to be limited by the specific embodiments disclosed below. Unless defined otherwise, all technical and scientific terms used herein have the same meaning as commonly understood by one of ordinary skill in the art to which the present application belongs. The terms used herein in the present application are only for the purpose of describing specific embodiments and are not intended to limit the present application.

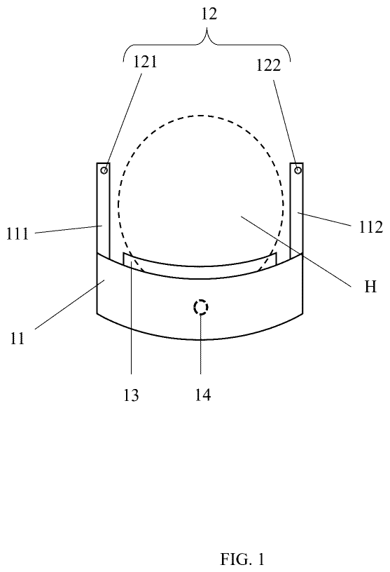

FIG. 1 is a first structural diagram of a VR device provided in an embodiment of the present application.

In one embodiment, the VR device 1 includes, but is not limited to: a main body 11, at least one speaker 12, a light shield 13, a microphone 14, a left temple 111 and a right temple 112. The left temple 111 is installed on one end of the main body 11, and the right temple 112 is installed on an opposite end of the main body 11. The at least one speaker 12 is installed on the left temple 111 or/and the at least one speaker 12 is installed on the right temple 112. The light shield 13 is installed on one end of the main body 11. The microphone 14 is installed on the side of the main body 11 that is away from the light shield 13. As shown in FIG. 1, H represents a head region of a wearer.

In one embodiment, due to differences in the facial shapes of wearers of the VR device 1, the light shield 13 of the VR device 1 may have light leakage issues, affecting the wearer's viewing experience. By providing a microphone 14 in the VR device 1, the VR device 1 controls the at least one speaker 12 to emit sound, and based on the sound in the audio frequency received by the microphone 14, it is determined whether a wearing status of the light shield 13 of the VR device 1 is normal. In response that the wearing status of the light shield 13 of the VR device is abnormal, the wearing position of the light shield 13 is adjusted until the light shield 13 is worn normally. The problem of light leakage caused by abnormal wearing of the light shield 13 is solved, and the viewing experience of the wearer is improved.

In one embodiment, in response that the wearer watches a media, the light shield 13 and the wearer's face are completely fitted together to form a sealed space, the microphone 14 receives a smaller sound when the speaker 12 emits sound. In response that the wearer watches a media, there is a gap between the light shield 13 and the wearer's face, the microphone 14 receives a larger sound when the speaker 12 emits sound. Thus, whether the light shield 13 is worn abnormally can be determined based on the volume range of the audio frequency received by the microphone 14, ensuring that the light shield 13 is worn normally during use by the wearer.

In one embodiment, the at least one speaker 12 is a left speaker, the left speaker is installed on the left temple 111, or/and the at least one speaker 12 is a right speaker, the right speaker is installed on the right temple 122. The at least one speaker 12 is a left speaker, the left speaker is installed on the right temple 122, or/and the at least one speaker 12 is a right speaker, the right speaker is installed on the left temple 111. The at least one speaker 12 is installed on the left side of the main body 11 of the VR device 1, or/and the at least one speaker 12 is installed on the right side of the main body 11 of the VR device 1, which is beneficial for the wearer to receive the audio frequency of the media well, thereby the viewing experience of the wearer is improved.

In one embodiment, the microphone 14 is installed at the center position of the main body 11, and this embodiment does not limit the specific mounting position of the microphone 14. For example, the microphone 14 is installed on a side of the main body 11 close to the right temple 112, or the microphone 14 is installed on a side of the main body 11 close to the left temple 111. The microphone 14 is configured for receiving audio frequency emitted by the left speaker 121, and/or the microphone 14 is configured for receiving audio frequency emitted by the right speaker 122.

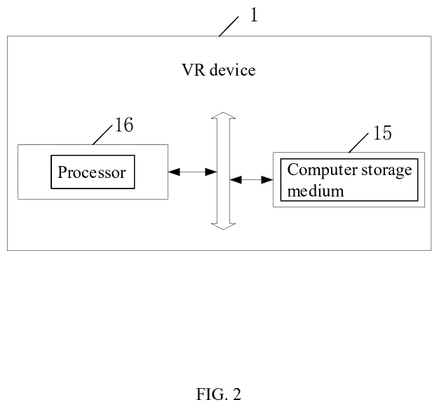

FIG. 2 is a second structural diagram of a VR device provided in an embodiment of the present application.

In one embodiment, the anomaly detection method for a VR device is applied to one or more VR devices 1, the VR device 1 being a device capable of automatically performing numerical calculations and/or information processing according to preset or stored computer programs, with its hardware including, but not limited to, a microprocessor, an Application Specific Integrated Circuit (ASIC), a Field-Programmable Gate Array (FPGA), a Digital Signal Processor (DSP), an embedded device, etc.

The network in which the VR device 1 is includes, but is not limited to: the Internet, a wide area network, a metropolitan area network, a local area network, a Virtual Private Network (VPN), etc.

In one embodiment, the VR device 1 further includes a computer storage medium 15 and at least one processor 16, the computer storage medium 15 storing a computer program executable on the processor 16, such as a control program for the VR device 1.

Those skilled in the art can understand that the schematic diagram is merely an example of the VR device 1 and does not constitute a limitation on the VR device 1. It may include more or fewer components than shown, or combine certain components, or have different components. For example, the VR device 1 may also include input/output devices, network access devices, buses, etc.

The at least one processor 16 may be a Central Processing Unit (CPU), and may also be other general purpose processors, Digital Signal Processor (DSP), Application Specific Integrated Circuit (ASIC), or other volatile solid state memory devices, Integrated Circuit (ASIC), Field-Programmable Gate Array (FPGA) or other programmable logic device, discrete gate or transistor logic device, discrete hardware component, etc. The general-purpose processor may be a microprocessor or the processor may also be any other conventional processor, etc. The at least one processor 16 is the computational core and control center of the VR device 1, utilizing various interfaces and lines to connect various parts of the entire VR device 1, and executing the operating system of the VR device 1 as well as various installed applications, program codes, etc.

The computer storage medium 15 may be an external memory and/or an internal memory of the VR device 1. Further, the computer storage medium 15 may be a physically tangible memory, such as a memory stick, a TF card (Trans-flash Card), etc.

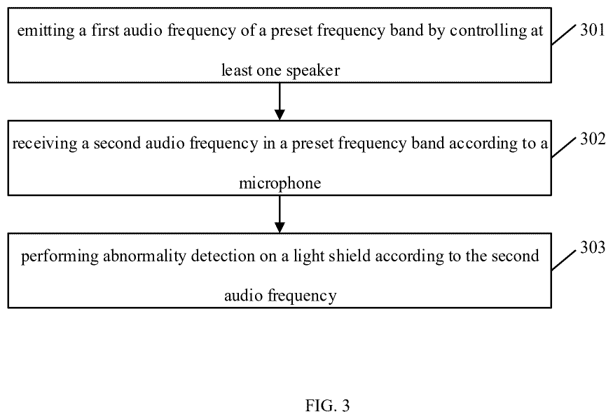

In conjunction with FIG. 3, the computer storage medium 15 in the VR device 1 stores a computer program, and the processor 16 can execute the computer program stored in the computer storage medium 15 to implement the anomaly detection method for a VR device as shown in FIG. 3.

FIG. 3 is a flowchart diagram of an anomaly detection method provided in an embodiment of the present application. An anomaly detection method for a VR device is applied to a VR device (e.g., the VR device 1 in FIG. 1 and FIG. 2). The VR device includes: a main body, at least one speaker, a light shield, a microphone, a left temple and a right temple. The left temple is installed on one end of the main body, and the right temple is installed on an opposite end of the main body. The at least one speaker is installed on the left temple or/and the at least one speaker is installed on the right temple. The light shield is installed on one end of the main body. The microphone is installed on the side of the main body that is away from the light shield. As shown in FIG. 3, the order of steps in the flowchart may be changed according to different requirements, and some steps may be omitted.

In block 301, the VR device emits a first audio frequency of a preset frequency band by controlling the speaker.

In one embodiment, the speaker is a sound-emitting module for the microphone. The speaker is installed on the main body of the VR device. The speaker is configured for emitting an audio frequency for users to listen to.

In one embodiment, the first audio frequency is preset according to the preset detection requirements of the VR device for detecting whether the visor is worn abnormally, and this embodiment of the application does not impose limitations here. For example, the first audio frequency may be a frequency band in any media where the microphone can receive sound.

In block 302, the VR device receives a second audio frequency in a preset frequency band according to the microphone.

In one embodiment, in response that the first audio frequency is emitted from the speaker and can be diffracted in multiple directions when passing through the obstruction, the microphone receives the sound waves diffracted by the first audio frequency. In one embodiment, the second audio is the sound waves diffracted by the first audio frequency.

In one embodiment, the speaker and the microphone are both installed on the main body, the speaker is configured for emitting the first audio frequency, and the microphone is configured for receiving sound waves diffracted from the first audio frequency emitted by the speaker. Therefore, the distance between the microphone and the speaker affects the magnitude of the sound waves received by the microphone. Specifically, the farther the distance between the microphone and the speaker, the stronger the sound waves received by the microphone, the closer the distance between the microphone and the speaker, the weaker the sound waves received by the microphone.

In block 303, the VR device performs abnormality detection on the light shield according to the second audio frequency.

In one embodiment, the volume of the second audio frequency reflects the wearing status of the light shield of the VR device. Therefore, the VR device detects whether the wearing status of the light shield of the VR device is abnormal and which side of the light shield of the VR device has a wearing issue according to the volume of the second audio frequency.

In one embodiment, the VR device determines a volume range according to a distance between the microphone and the at least one speaker, and determines whether a wearing status of the light shield of the VR device is normal according to the second audio frequency and the volume range.

In one embodiment, the volume range is preset based on the distance between the microphone and the speaker in the VR device. For example, in response that the distance between the microphone and the speaker is M, the volume range is preset to V1<V<V2, in response that the distance between the microphone and the speaker is N, the volume range is preset to V3<V<V4. In some embodiments, M>N, V1<V3, and V2<V4.

In one embodiment, the VR device receives the first audio frequency from the speaker, and the first audio frequency is diffracted in multiple directions around the edge of the obstruction during the propagation process to obtain the second audio frequency. Therefore, an intensity of the sound wave of the second audio frequency is affected by the obstruction. For example, in practical applications, in response that the light shield and the wearer's face are completely fitted together to form a sealed space, the intensity of the sound waves diffracted in multiple directions received by the microphone is weaker, and thus the sound wave intensity of the second audio frequency is weaker. In response that there is a gap between the light shield and the wearer's face, the intensity of the sound waves diffracted in multiple directions received by the microphone is stronger, and thus the sound wave intensity of the second audio frequency is stronger.

In one embodiment, the distance between the microphone and the at least one speaker may affect the intensity of the sound waves of the audio frequency received by the microphone. The VR device determines the volume range by the distance between the microphone and the at least one speaker, and compares the volume range with the volume of the second audio frequency. Specifically, the VR device determines whether the wearing status of the light shield is normally according to the comparison result. The VR device determines the volume range according to the distance between the microphone and the at least one speaker. The volume range is not a pre-set fixed value, and the accuracy of the anomaly detection results is improved. In response that watching a media, the VR device ensures that the wearing status of the light shield of the VR device is normal according to the comparison result, and the viewing effect is improved.

In one embodiment, the VR device obtains a first distance between a left speaker of the at least one speaker and the microphone, and determines the volume range according to the first distance and a first volume of the first audio frequency. In some embodiments, the left speaker is installed on the left temple or the right temple.

For example, in response that the VR device includes one left speaker, the left speaker is installed on the left temple, and the left speaker is controlled to emit the first audio frequency, the second audio frequency received by the microphone is emitted by the left speaker. The VR device determines the volume range received by the microphone according to the first distance between the left speaker and the microphone and the first volume of the first audio frequency, and further determines whether the left side of the light shield is worn normally according to the volume range.

In one embodiment, the VR device obtains a second distance between a right speaker of the at least one speaker and the microphone, and determines the volume range according to the second distance and the first volume of the first audio frequency. In some embodiments, the at least one speaker is a right speaker,

For example, in response that the VR device includes one right speaker, the right speaker is installed on the right temple, and the right speaker is controlled to emit the first audio frequency, the second audio frequency received by the microphone is emitted by the right speaker. The VR device determines the volume range received by the microphone according to the second distance between the right speaker and the microphone and the first volume of the first audio frequency, and further determines whether the right side of the light shield is worn normally according to the volume range.

In one embodiment, the VR device obtains a third distance between a left speaker of the at least one speaker and the microphone, and obtains a fourth distance between a right speaker of the at least one speaker and the microphone. The VR device determines the volume range according to the third distance, the fourth distance and a first volume of the first audio frequency. In some embodiments, the left speaker is installed on the left temple, and the right speaker is installed on the right temple, or the left speaker is installed on the right temple, and the right speaker is installed on the left temple.

For example, in response that the VR device includes one left speaker and one right speaker, and the left speaker and the right speaker are controlled to simultaneously emit the first audio frequency, the second audio frequency received by the microphone is emitted by both the left speaker and the right speaker. The VR device determines the volume range received by the microphone according to the third distance between the left speaker and the microphone, the fourth distance between the right speaker and the microphone, and the first volume of the first audio frequency, and further determines whether the light shield is worn normally according to the volume range.

In one embodiment, in response that a second volume of the second audio frequency is within the volume range, determining the wearing status of the light shield of the VR device is normal. In response that the second volume of the second audio frequency is not within the volume range, determining the wearing status of the light shield of the VR device is abnormal.

In at least one embodiment, in response that the light shield fits the wearer's face shape, and the light shield has good airtightness, the microphone receives a smaller sound, and the second volume of the second audio frequency will be within the volume range. In response that the light shield does not fit the wearer's face shape, and there may be a light leakage issue with the light shield, the microphone receives a larger sound, the second volume of the second audio frequency may exceed the volume range.

In one embodiment, in response that the wearing status of the light shield of the VR device is abnormal, sending a voice prompt message configured for adjusting a position of the light shield.

In one embodiment, in response that the second volume of the second audio frequency exceeds the volume range, the VR device determines which side of the light shield is worn abnormally. For example, the VR device controls the left speaker to emit a third audio frequency of the preset frequency band, and the microphone receives a fourth audio frequency corresponding to the third audio frequency of the preset frequency band. The VR device determines the side where the light shield is worn abnormally according to the distance between the left speaker and the microphone, the third volume of the third audio frequency, and the fourth volume of the fourth audio frequency, and then the VR device sends out the voice prompt message. In some embodiments, the voice prompt message includes information on which side of the light shield to adjust. In response that the light shield is worn abnormally, by promptly adjusting the light shield until it is worn normally, and the viewing effect is improved.

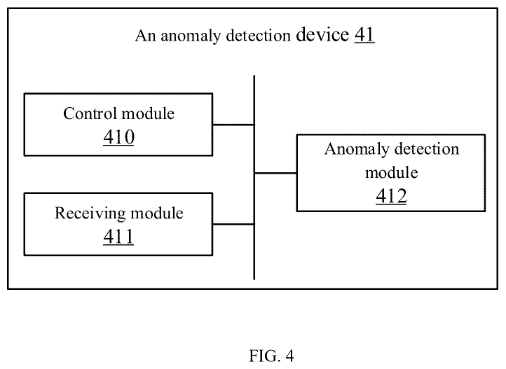

FIG. 4 shows a schematic structural diagram of an anomaly detection device provided in an embodiment of the present application. The anomaly detection device 41 is applied to a VR device, the VR device includes a main body, at least one speaker, a light shield, a microphone, a left temple and a right temple. The left temple is installed on one end of the main body, and the right temple is installed on an opposite end of the main body. The at least one speaker is installed on the left temple or/and the at least one speaker is installed on the right temple, the light shield is installed on one end of the main body. The microphone is installed on the side of the main body that is away from the light shield. In some embodiments, the VR device operates with a computer storage medium 15. The computer storage medium 15 includes a plurality of storage units. The anomaly detection device 41 includes a control module 410, a receiving module 411, and an anomaly detection module 412. The modules/units referred to in this application are a series of computer program segments capable of being acquired by the processor 16 and performing fixed functions, stored in the computer storage medium 15.

The control module 410 is configured for emitting a first audio frequency of a preset frequency band by controlling the speaker. The receiving module 411 is configured for receiving a second audio frequency in a preset frequency band according to the microphone. The anomaly detection module 412 is configured for performing abnormality detection on the light shield according to the second audio frequency.

If the modules/units integrated in the VR device 1 are implemented in the form of software functional units and sold or used as independent products, they can be stored in a computer-readable storage medium. Based on this understanding, this application implements all or part of the processes in the methods of the above embodiments, which can also be completed by instructing related hardware through a computer program. The computer program can be stored in a computer-readable storage medium, and when the computer program is executed by a processor, it can implement the steps of the above method embodiments.

The computer program includes computer program code, which may be in source code form, object code form, executable file, or some intermediate form, etc. The computer-readable medium may include: any entity or device capable of carrying the computer program code, a recording medium, a USB flash drive, a removable hard disk, a magnetic disk, an optical disk, a computer memory, a Read-Only Memory (ROM), a Random Access Memory (RAM).

The computer storage medium 15 can be configured to store the computer-readable instructions and/or modules/units. The processor 16 may run or execute the computer-readable instructions and/or modules/units stored in the computer storage medium 15 and may call up data stored in the computer storage medium 15 to implement various functions of the VR device 1. The computer storage medium 15 mainly includes a storage program area and a storage data area. The storage program area may store an operating system, and an application program required for at least one function (such as a sound playback function, an image playback function, etc.), etc., The storage data area may store data (such as audio data, phone book data, etc.) created according to the use of the VR device 1. In addition, the computer storage medium 15 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

For example, the computer program can be divided into one or more modules/units, and one or more modules/units are stored in the computer storage medium 15 and executed by the processor 16 to complete this application. One or more modules/units may be a series of computer program segments capable of completing specific functions, and the computer program segments are used to describe the execution process of the computer program in the VR device 1. For example, the computer program can be divided into a control module 410, a receiving module 411, and an anomaly detection module 412.

For detailed descriptions of the functions of each module/unit, reference can be made to the detailed description of FIG. 3 above, which will not be repeated here.

In one embodiment, the microphone and the at least one speaker are both installed on the main body of the VR device, the microphone receives a second audio frequency corresponding to a first audio frequency emitted by the speaker, and whether the light shield of the VR device is worn abnormally is determined according to the volume of the second audio frequency, thereby preventing the wearer from viewing content while the light shield is worn abnormally, and the viewing effect is improved.

In several embodiments provided by this application, it should be understood that the disclosed systems, apparatuses, and methods can be implemented in other ways. For example, the apparatus embodiments described above are merely illustrative, for example, the division of modules is merely a logical function division, and in actual implementation, there may be other division methods.

The modules described as separate components may or may not be physically separated, and the components displayed as modules may or may not be physical units. That is, it can be located in one place, or distributed to multiple network units. Some or all of the modules can be selected according to actual needs to achieve the purpose of the solution of above embodiments.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim.

Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure, rather than restrictions on the technical solutions. Although the present disclosure has been described in detail with reference to the above embodiments, those skilled in the art should understand that the technical solutions described in one embodiments can be modified, or some of technical features can be equivalently substituted, and these modifications or substitutions are not to detract from the essence of the corresponding technical solutions or from the scope of the technical solutions of the embodiments of the present disclosure.

What is claimed is:

1. An anomaly detection method applied to a Virtual Reality (VR) device, wherein the VR device comprising a main body, at least one speaker, a light shield, a microphone, a left temple and a right temple, the left temple is installed on one end of the main body, and the right temple is installed on an opposite end of the main body, the at least one speaker is installed on the left temple or/and the at least one speaker is installed on the right temple; the light shield is installed on one end of the main body; the microphone is installed on the side of the main body that is away from the light shield;
the anomaly detection method comprising:
emitting a first audio frequency of a preset frequency band by controlling the at least one speaker;
receiving a second audio frequency in a preset frequency band according to the microphone; and
performing abnormality detection on the light shield according to the second audio frequency.

2. The method of claim 1, further comprising:
determining a volume range according to a distance between the microphone and the at least one speaker; and
wherein performing abnormality detection on the light shield according to the second audio frequency comprises:
determining whether a wearing status of the light shield of the VR device is normal according to the second audio frequency and the volume range.

3. The method of claim 2, wherein determining the volume range according to the distance between the microphone and the at least one speaker comprises:
obtaining a first distance between a left speaker of the at least one speaker and the microphone;
determining the volume range according to the first distance and a first volume of the first audio frequency.

4. The method of claim 2, wherein determining the volume range according to the distance between the microphone and the at least one speaker comprises:
obtaining a second distance between a right speaker of the at least one speaker and the microphone;
determining the volume range according to the second distance and a first volume of the first audio frequency.

5. The method of claim 2, wherein determining the volume range according to the distance between the microphone and the at least one speaker comprises:
obtaining a third distance between a left speaker of the at least one speaker and the microphone, and obtaining a fourth distance between a right speaker of the at least one speaker and the microphone;
determining the volume range according to the third distance, the fourth distance and a first volume of the first audio frequency.

6. The method of claim 5, wherein determining whether the wearing status of the light shield of the VR device is normal according to the second audio frequency and the volume range comprises:
in response that a second volume of the second audio frequency is within the volume range, determining the wearing status of the light shield of the VR device is normal;
in response that the second volume of the second audio frequency is not within the volume range, determining the wearing status of the light shield of the VR device is abnormal.

7. The method of claim 2, further comprising:
in response that the wearing status of the light shield of the VR device is abnormal, sending a voice prompt message configured for adjusting a position of the light shield.

8. A VR device comprising:
a main body; at least one speaker; a light shield; a microphone; a left temple and a right temple, wherein the left temple is installed on one end of the main body, and the right temple is installed on an opposite end of the main body, the at least one speaker is installed on the left temple or/and the at least one speaker is installed on the right temple; the light shield is installed on one end of the main body; the microphone is installed on a side of the main body away from the light shield;
a processor; and
a storage device storing a plurality of instructions, which when executed by the processor, cause the processor to:
emit a first audio frequency of a preset frequency band by controlling the at least one speaker;
receive a second audio frequency in a preset frequency band according to the microphone; and
perform abnormality detection on the light shield according to the second audio frequency.

9. The VR device of claim 8, wherein the processor is further caused to:
determine a volume range according to a distance between the microphone and the at least one speaker; and
wherein perform abnormality detection on the light shield according to the second audio frequency comprises:
determine whether a wearing status of the light shield of the VR device is normal according to the second audio frequency and the volume range.

10. The VR device of claim 9, comprising one speaker, the speaker is installed on the left temple or the right temple, the processor is further caused to:
obtain the distance between the speaker and the microphone; and
wherein determine the volume range according to the distance between the microphone and the at least one speaker comprises:
determine the volume range according to the distance and a first volume of the first audio frequency.

11. The VR device of claim 9, comprising a left speaker and a right speaker, the left speaker is installed on the left temple, and the right speaker is installed on the right temple, the processor is further caused to:
obtain a third distance between the left speaker and the microphone, and obtain a fourth distance between the right speaker and the microphone; and
wherein determine the volume range according to the distance between the microphone and the at least one speaker comprises:
determine the volume range according to the third distance, the fourth distance and a first volume of the first audio frequency.

12. The VR device of claim 11, wherein the processor is further caused to:
in response that a second volume of the second audio frequency is within the volume range, determining the wearing status of the light shield of the VR device is normal;
in response that the second volume of the second audio frequency is not within the volume range, determining the wearing status of the light shield of the VR device is abnormal.

13. The VR device of claim 12, wherein the processor is further caused to:
in response that the wearing status of the light shield of the VR device is abnormal, sending a voice prompt message configured for adjusting a position of the light shield.

14. A non-transitory storage medium having stored thereon at least one computer-readable instructions that, when executed by a VR device, causes the VR device to perform an anomaly detection method, the VR device comprising a main body, at least one speaker, a light shield, a microphone, a left temple and a right temple, the method comprising:
emitting a first audio frequency of a preset frequency band by controlling the at least one speaker;
receiving a second audio frequency in a preset frequency band according to the microphone;
performing abnormality detection on the light shield according to the second audio frequency.

15. The non-transitory storage medium of claim 14, further comprising:
determining a volume range according to a distance between the microphone and the at least one speaker; and
wherein performing abnormality detection on the light shield according to the second audio frequency comprises:
determining whether a wearing status of the light shield of the VR device is normal according to the second audio frequency and the volume range.

16. The non-transitory storage medium of claim 15, wherein determining the volume range according to the distance between the microphone and the at least one speaker comprises:
obtaining a first distance between a left speaker of the at least one speaker and the microphone;
determining the volume range according to the first distance and a first volume of the first audio frequency.

17. The non-transitory storage medium of claim 15, wherein determining the volume range according to the distance between the microphone and the at least one speaker comprises:
obtaining a second distance between a right speaker of the at least one speaker and the microphone;
determining the volume range according to the second distance and a first volume of the first audio frequency.

18. The non-transitory storage medium of claim 15, wherein determining the volume range according to the distance between the microphone and the at least one speaker comprises:
obtaining a third distance between a left speaker of the at least one speaker and the microphone, and obtaining a fourth distance between a right speaker of the at least one speaker and the microphone;
determining the volume range according to the third distance, the fourth distance and a first volume of the first audio frequency.

19. The non-transitory storage medium of claim 18, wherein determining whether the wearing status of the light shield of the VR device is normal according to the second audio frequency and the volume range comprises:
in response that a second volume of the second audio frequency is within the volume range, determining the wearing status of the light shield of the VR device is normal;
in response that the second volume of the second audio frequency is not within the volume range, determining the wearing status of the light shield of the VR device is abnormal.

20. The non-transitory storage medium of claim 19, further comprising:
in response that the wearing status of the light shield of the VR device is abnormal, sending a voice prompt message configured for adjusting a position of the light shield.
